(19) United States
(12) Patent Application Publication
(10) Pub. No.: US 2010/0143855 A1
(43) Pub. Date: Jun. 10, 2010

(54) ORTHODONTIC ANTERIOR OPEN-BITE SPLINT

(75) Inventor: Nicole Marie Scheffler, Boon, NC (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/444,053

(22) PCT Filed: Oct. 10, 2007
(86) PCT No.: PCT/US2007/080933

§ 371 Date: Jan. 26, 2010

Related U.S. Application Data
(60) Provisional application No. 60/850,624, filed on Oct. 10, 2006.

(51) Int. Cl. A61C 7/00

(52) U.S. Cl. 433/6

(57) ABSTRACT

An anterior open-bite splint (10) provides an intrusion force to posterior teeth to aid in correcting anterior open-bites. Splint (10) includes bite plats (12, 14) and attachment devices (20). Splint 10 may also form a part of an orthodontic treatment assembly that also includes orthodontic coil springs (22) and orthodontic implants (24)

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosure of which is expressly incorporated by reference herein in its entirety.

### TECHNICAL FIELD

This invention generally relates to orthodontic devices aimed at treating an anterior open bite.

### BACKGROUND

One of the most challenging cases that orthodontist have to deal with on a regular basis is resolving an anterior open bite. Various treatment methods have been proposed over the years and have ranged from using functional appliances to using orthognathic surgery. The drawbacks associated with the current treatment methods are as follows: surgery—this option results in the “quickest fix” but is very invasive and not a preferred option to many patients; using a fixed appliance to extrude anterior teeth—this option often results in unaesthetic and unstable results; and, using functional appliances, headgear or a posterior bite block to maintain the vertical position of posterior teeth while allowing the continued eruption of the anterior teeth—this option relies on patient cooperation and growth of the patient and cannot be relied on for adult patients.

Therefore, what is needed is an orthodontic device that will correct an anterior open-bite in a less-invasive, more stable manner than current devices and techniques.

### SUMMARY

The present invention is an anterior open-bite splint. This appliance is generally similar to some existing posterior bite plate appliances in that it relies on intrusion of posterior tooth to close the open bite, rather than extrusion of the anterior teeth. However, unlike existing appliances, the present invention is specifically designed and intended to be used in conjunction with temporary anchorage devices (aka orthodontic mini-screws or implants), of the type disclosed in co-pending PCT International Application No. ______, filed Oct. 10, 2007, and entitled “Orthodontic Implants,” which is expressly incorporated by reference herein in its entirety.

In its broadest aspects, the present invention include a posterior bite plate having a plurality of hook or eyelet members for engaging orthodontic springs, which are in turn connected to orthodontic implants. By combining these two approaches, the clinician is able to achieve results that are not possible with approaches other than surgery. For example, to achieve intrusion, current posterior bite plates alone rely on impact to provide the desired intrusive forces. However, this force is intermittent since no force is applied when the patient opens their mouth and the patient does not bite continuously throughout the day. Advantageously, the device of the present invention applies a constant intrusive force through the use of the coil springs that are connected to the splint and to the implants. Moreover, current posterior bite plates do not provide any other force vectors than an intrusive force vector. Advantageously, the device of the present invention allows for a distalizing or mesializing force to be applied to the maxilla in order to resolve any Class II (overbite) or Class III tendencies in the patient, while at the same time providing the intrusive force to connect the anterior open bite.

### BRIEF DESCRIPTION OF THE DRAWINGS

Various additional features and aspects will become readily apparent to those of ordinary skill in the art from the following description of illustrative embodiments of the invention and from the drawings in which:

FIG. 1 is a perspective view showing a portion of a posterior open bite splint according to the present invention in an oral environment; and

FIG. 2 is a plan view showing a posterior open bite splint in accordance with the present invention.

### DETAILED DESCRIPTION

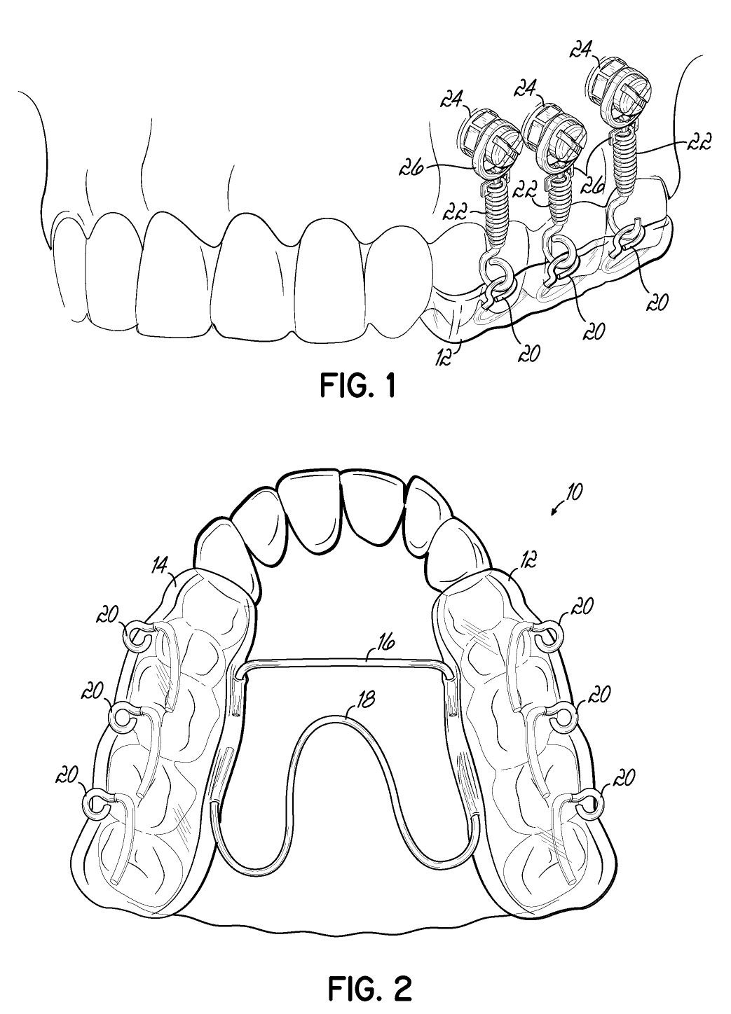

FIG. 2 shows a bottom plan view of a posterior open bite splint 10 of the present invention and FIG. 1 shows the device in place on the maxilla of a patient. As best seen in FIG. 2, splint 10 includes two bite members 12 and 14 which overlie selected portions of the posterior teeth in the maxillary arch. These bite members or plates 12 and 14 provide a bite surface to transmit intrusive forces to the desired teeth. Bite plates 12 and 14 may be made of a variety of suitable materials. Particularly useful is an acrylic material, both because of its durability and because it is generally transparent. Bite plates 12 and 14 are connected to each other via transpalatal wires 16 and 18 that may provide other treatment force vectors.

In order to use the posterior open bite splint of the present invention to effect continuous intrusion force vectors on the posterior teeth of a patient having an anterior open bite, splint 10 is provided with a series of hook members 20 which are embedded in the acrylic material of both plates 12 and 14. As shown in FIG. 1, these hook members are on the labial side of the bite plates 12, 14 and extend generally upwardly to facilitate the connection of the open bite splint of the present invention to orthodontic implants 24, which have been affixed to the patient's skeletal structure. As shown, hook member 20 embedded in bite plate 12 are connected to orthodontic implants 24 via coil springs 22. The coil springs 22 may have a swivel eyelet 26 at one or both ends thereof to facilitate interconnection between hooks 20 on open bite splint 10 and implants 24.

As an alternative to hooks 20, posterior open bite splint 10 may include eyelets or buttons for attachment of a coil spring hook or eyelet. It will be appreciated that coil springs 22 and eyelets 26 may be of one of the types disclosed in co-pending PCT International application No. ______, filed Oct. 10, 2007, entitled “Orthodontic Auxiliary Device having a Swivel for adapting to Implants,” which is expressly incorporated by reference herein in its entirety. It will be further appreciated that orthodontic implants 24 may be of one of the types disclosed in co-pending PCT International application No. ______, filed Oct. 10, 2007 and entitled “Orthodontic Implants” which is expressly incorporated by reference herein in its entirety.

As will be further appreciated, depending on which coil spring 22 is attached to which orthodontic implant 24, the clinician can manipulate the force vectors to be used in a particular treatment. By placing coil springs 22 in an angled orientation with temporary implants that are either toward the posterior or anterior of the oral cavity, the clinician can induce mesializing and distalizing forces on the posterior teeth, in addition to the intrusive forces due to the upward component of the spring force.

While the present invention has been illustrated by description of one or more embodiments and while these embodiments have been described in detail, it is not the intention of the applicant to restrict or in any way limit the scope of the claims to such detail. Additional advantages and modifications will readily appear to those skilled in the art. The invention in its broader aspects is, therefore, not limited to the specific details, representative systems, apparatus and method, and illustrative examples shown and described. Accordingly, departures may be made from such details without departing from the spirit or scope of the applicant's inventive concept.

What is claimed is:

1. An anterior open-bite splint, comprising:
dual posterior bite plates;
a transpalatal connector or extending between and connecting said posterior bite plates; and
a plurality of attachment devices extending generally upwardly and labially from said bite plates.

2. The anterior open-bite splint of claim 1 wherein said attachment devices are hooks, eyelets, buttons or combinations thereof.

3. The anterior open-bite splint of claim 1, wherein said bite plates are molded acrylic and said attachment devices are at lease partially embedded therein.

4. An anterior open-bite splint, comprising:
dual, molded acrylic posterior bite plates;
a transpalatal connector extending between and connecting said bite plates; and
a plurality of attachment hooks, eyelets, buttons or combinations thereof, extending generally upwardly and labially from said bite plates.

5. An orthodontic treatment assembly, comprising:
an anterior open-bite splint, comprising:
dual posterior bite plates;
a transpalatal connector extending between and connecting said posterior bite plates; and
a plurality of attachment devices extending generally upwardly and labially from said bite plates;
a plurality of orthodontic coil barrings each connected at one end thereof to one of said attachment devices of said anterior open-bite splint; and
at least one orthodontic implant for implantation into a patient's skeletal structure, said implant including a head and neck portion for engaging an end of said coil spring opposite the end engaging of said attachment devices.

6. An orthodontic treatment assembly of claim 5 wherein said attachment devices are hooks, eyelets, buttons or combinations thereof.

7. An orthodontic treatment assembly of claim 5 wherein said bite plates are molded acrylic and said attachment devices are at least partially embedded therein.
